(19) United States
(12) Patent Application Publication
(10) Pub. No.: US 2017/0124618 A1
(43) Pub. Date: May 4, 2017

(54) Methods and Systems for Image-Based Searching of Product Inventory

(71) Applicant: DirectBuy, Inc., Merrillville, IN (US)

(72) Inventors: Armin Roeseler, Chicago, IL (US); Chiranjoy Das, Carmel, IN (US)

(21) Appl. No.: 14/928,126

(22) Filed: Oct. 30, 2015

Related U.S. Application Data
(60) Provisional application No. 62/248,513, filed on Oct. 30, 2015.

(51) Int. Cl. G06Q 30/06; G06F 17/30

(52) U.S. Cl. CPC G06Q 30/0623; G06F 17/30277; G06F 17/3053; G06F 17/30271; G06F 17/30259

(57) ABSTRACT

Methods and systems for searching electronic product catalogue data using search queries developed from user uploaded image files are disclosed. In some embodiments, the methods include the following: providing product data including product image and text files and feature vectors based on the image and text files, the product data being stored in a search database; providing a graphical user interface (GUI) configured to allow a user to upload search image files of products the user desires to search; uploading a search image file of a product to be searched via the GUI; analyzing the search image file to determine its feature vectors; querying the search database using the search image file's feature vectors to develop a ranking of the product image files including feature vectors that match the feature vectors of the search image file; and displaying the image and text files for the ranked product image files.

### CROSS REFERENCE TO RELATED APPLICATION(S)

This application claims the benefit of U.S. Provisional Application No. 62/248,513, filed Oct. 30, 2015, which is incorporated by reference as if disclosed herein in its entirety.

### BACKGROUND

Currently, shopping websites offer hierarchical menus that require the shopper to specify merchandise attributes, e.g., style, color, size, and weight, etc., to narrow down a product choice. As such, the shopper needs to decompose an object, e.g., colonial style coffee table, into attributes that are pre-defined by the website. Based on the mapping, available merchandise choices are presented.

Known technologies do not provide an easy and effective way to search a product catalog to find the availability of a product based on a given image. Additionally, although the available technologies can identify a product based on an image, they typically don't always return similar objects sorted based on certain criteria. Once it identifies, the next level of search is based on text, for example, Black→Office→Chair, but shape or pattern of the object is not taken into consideration.

### SUMMARY

Aspects of the disclosed subject matter include methods and systems for image-based searching of product inventory. Referring now to FIG. 1, in some embodiments, a user uploads an image of a product to be searched via a graphical user interface running on a website, a smartphone, a tablet, or other computer device to an online system for image-based searching of product inventory. Using computer implemented methods, the system analyzes and parses data from the image. The parsed data is used to query a system database that includes image data of product inventory, which is typically uploaded via a separate offline process. The query results are ranked with the product data having image data that is closest to the parsed data having a higher ranking The results are displayed to the user via the graphical user interface. Typically, the results include links that allow a user to both learn more information and purchase the products included in the results.

Using method and systems according to the disclosed subject matter, mapping and decomposition of an object into merchandise attributes does not have to be performed. Instead, the shopper simply uploads an image, taken, for example, with a mobile phone of the object he or she desires, and the exact match or, if not available, like merchandise objects are presented to the shopper for selection. Desired merchandise specification is exclusively provided by an image presented, and no abstract decomposition of the merchandise into pre-defined attribute categories has to be performed.

Methods and systems according to the disclosed subject matter extract the features of a given image and then (a) search an entire catalog, (b) sort a list of similar products, (c) rank them as per features and price ranges, (d) integrate the search results with a merchant's e-commerce web site, and (e) provide the ability to add the product to the cart/wish list of the website.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1 is a schematic diagram of methods and systems according to some embodiments of the disclosed subject matter;

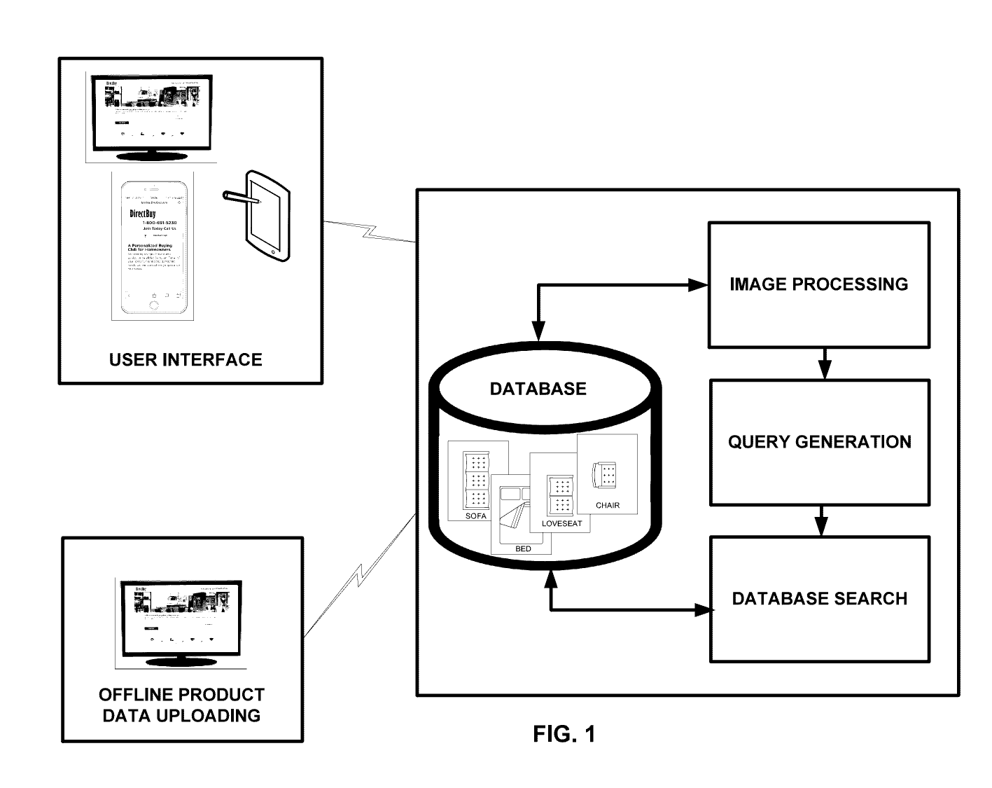

FIG. 2 is a schematic diagram of methods and systems according to some embodiments of the disclosed subject matter; and

FIG. 3 is a chart of a method according to some embodiments of the disclosed subject matter.

### DETAILED DESCRIPTION

Aspects of the disclosed subject matter include methods and systems for searching electronic product catalogue data using search queries at least partially developed from the attributes of uploaded digital image files. In some embodiments, the system functionality includes two separate parts: (1) an online interface that allows a user to upload images of products to be searched; and (2) and offline interface that allows a database owner to upload product data to maintain and grow the electronic product catalogue data stored in a content database.

When the online interface is in use, a user uploads an image of a desired item to a web server at a specific uniform resource locator (URL). The web-service responsible for that URL transfers the image, along with specified parameters, if any to an online content based image retrieval (CBIR) application and waits for response. On receiving the uploaded image, the CBIR application processes the image and creates an appropriate database query. The database query is run against the content database and the resulting closest image URLs are obtained, formatted, and presented to the user via the web service.

When the offline interface is initially used, images are processed one by one using an offline CBIR application (or the online CBIR application mentioned above). Appropriate descriptors and/or distance measures are created and the data is stored in the database for online querying. When new items are added to the catalog, the added images are also processed as per process by the online or offline CBIR application.

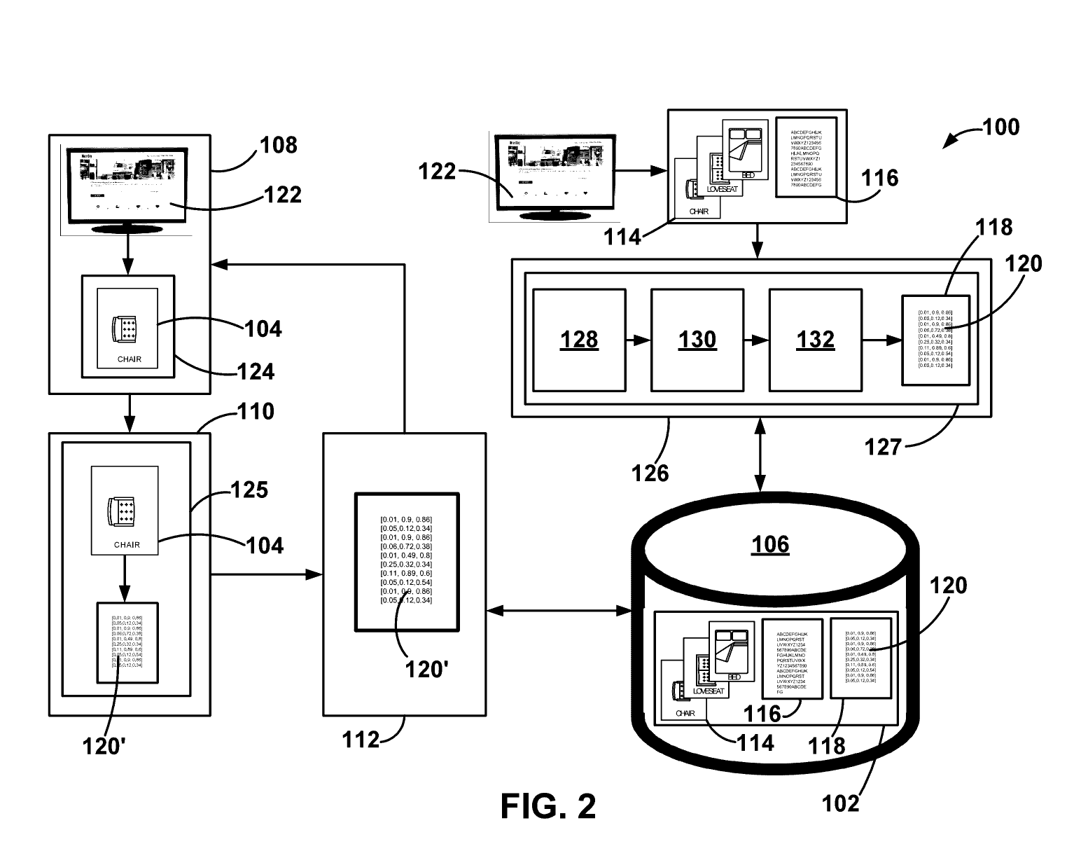

Still referring to FIG. 2, aspects of the disclosed subject matter include a system 100 for searching electronic product catalogue data 102 using search queries developed from user uploaded digital image files 104. In some embodiments, system 100 includes a product catalogue search database 106 for storing electronic product catalogue data 102, a web-based user interface module 108, a query generation module 110, and a search module 112, all of which are interconnected.

Product catalogue search database 106 includes electronic product catalogue data 102 for a plurality of products. Electronic product catalogue data 102 includes digital product catalogue image files 114, digital product catalogue text files 116, and content based image retrieval data 118. Content based image retrieval data 118 includes particularly formatted feature vectors 120, which are based on digital product catalogue image and text files 114, 116. Data included in digital product catalogue text files 116 is typically used to provide an identifying code (not shown) to each of feature vectors 120 that associates it with a particular one the plurality of products.

Web-based user interface module 108 includes a graphical user interface 122 having mechanisms 124 for allowing a user to upload digital product search image files 104 of products the user desires to search. Web-based user interface module 108 typically communicates with query generation module 110 via a load balancer and a web server (not shown). The load balancer increases the capacity of system 100 and allows concurrent users to access the system across a plurality of web servers.

Query generation module 110 includes computer implemented methods and systems for analyzing digital product search image files 104 to determine particularly formatted feature vectors 120′ of the digital product search image files. Query generation module 110 typically includes computer implemented methods that define an online content based image retrieval application 125. Query generation module 110 typically communicates with search module 112 and product catalogue search database 106 via a database abstraction layer and a database driver (not shown). The database driver converts queries developed in query generation module 110 into a protocol language that is compatible to talk with search module 112 and product catalogue search database 106 and converts query results from the protocol language to the language of the query generation module.

Search module 112 includes computer implemented methods and systems for querying product catalogue search database 106 using particularly formatted feature vectors 120′ of digital product search image files 104 that were generated query generation module 110 to develop a ranked list (not shown) of the digital product catalogue image files including particularly formatted feature vectors 120 that most closely match the particularly formatted feature vectors 120′ of the digital product search image files. Search module 112 also includes computer implemented methods for displaying to the user via graphical user interface 122 digital product catalogue image and text files (not shown) for each of the digital product catalogue image files on the ranking list.

In some embodiments, system 100 includes a product catalogue data analysis module 126 for processing digital product catalogue text and image files 114, 116 to generate electronic product catalogue data 102 that is stored in product catalogue search database 106. Module 126 typically communicates with product catalogue search database 106 via a database abstraction layer and a database driver (not shown). The database abstraction layer is an application programming interface that unifies the communication between a product catalogue data analysis module 126 and product catalogue search database 106 so that the module can communicate with myriad database structures. The database driver converts electronic product catalogue data 102 into a protocol language to talk to product catalogue search database 106 when storing the data in the database.

Module 126 is used for an initial plurality of products and thereafter to both supplement and update electronic product catalogue data 102 as necessary. Product catalogue data analysis module 126 includes computer implemented methods that define an offline CBIR application 127 for analyzing digital product catalogue text and image files 114, 116 to develop content based image retrieval data 118 and storing the content based image retrieval data in product catalogue search database 106. Content based image retrieval data 118 includes particularly formatted feature vectors 120 for a plurality of products, all of which are based on digital product catalogue image and text files 114, 116. In some embodiments, product catalogue data analysis module 126 is offline, but in communication with product catalogue search database 106. In some embodiments, product catalogue data analysis module 126 is online and in communication with product catalogue search database 106.

Referring now to FIG. 2, in some embodiments, CBIR application 127 includes an image file pre-processing sub-module 128 for pre-processing digital product catalogue image files 114 to facilitate extraction of features (not shown) from the files, a feature extraction sub-module 130 for extracting feature data from the digital product catalogue image files, and a feature classification sub-module 132 for classifying the feature data. In some embodiments, module 126 is used to generate both feature vectors 120 and 120′. In some embodiments, 120′ are generated by a separate module (not shown) that includes similar computer implemented methods and systems. In some embodiments, particularly those where vectors 120 and 120′ are generated by separated modules, module 126 is typically operated offline to populate database 106. In some embodiments, module 126 is online, i.e., accessible and operable via the World Wide Web, but is on accessible via a secured, e.g., password protected, etc., portal. As one skilled in the art will appreciate, myriad configurations with respect to the modules used to generate both feature vectors 120 and 120′ are both possible and contemplated.

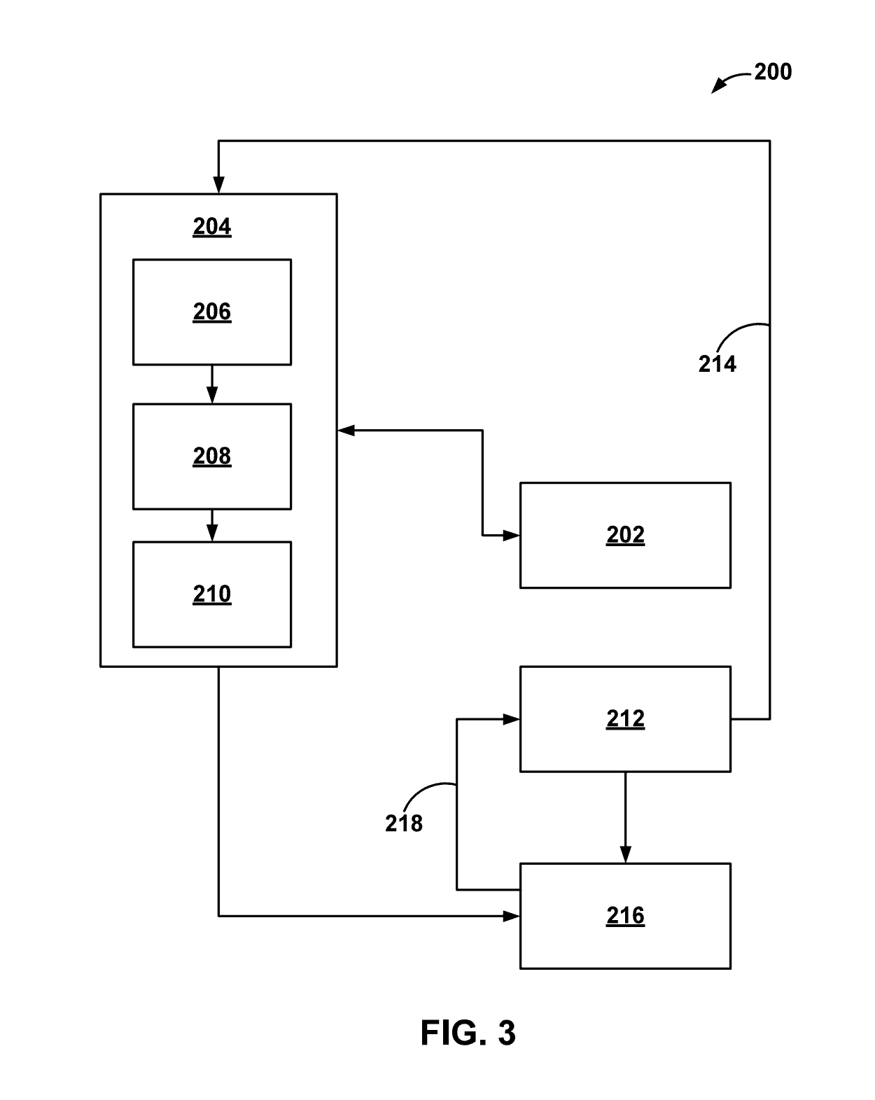

Referring now to FIG. 3, some embodiments include a method 200 for searching electronic product catalogue data using search queries developed from user uploaded digital image files. At 202, product catalogue data is provided for a plurality of products. The product catalogue data is stored in a product catalogue search database. The product catalogue data includes digital product catalogue image files, digital product catalogue text files, and content based image retrieval data having particularly formatted feature vectors. The content based image retrieval data and vectors are based on the digital product catalogue image and text files. The particularly formatted feature vectors typically include data that identifies particular features of each digital product catalogue image file and related text data that also serves to key each vector to a particular product. The contents of the particularly formatted feature vectors are typically dynamic, i.e., vary over time. As a result, in some embodiments, the product catalogue search database includes a non-relational structure, e.g., the database sold under the trademark MongoDB® or similar. However, in some embodiments, communication with the product catalogue search database is done via a database abstraction layer to allow the use of myriad database structures, including relational databases.

At 204, digital product catalogue text and image files are analyzed to develop the content based image retrieval data including particularly formatted feature vectors for a plurality of products. In some embodiments, at 206, analyzing digital product catalogue text and image files to develop content based image retrieval data includes pre-processing the digital product catalogue image files to facilitate extraction of features from the files. Pre-processing of the digital product catalogue image files includes using known image enhancement techniques and processes to improve the visual appearance of the images. Image enhancement includes accentuating and/or sharpening of various image features, such as edges, boundaries, contrast, etc.—all of which facilitate both the viewing and analyses of the enhanced images. Image enhancement techniques and process include manipulating the gray levels and contrast, reducing noise, making edges crisper and sharper, various filtering techniques, interpolating and magnifying where necessary, and coloring. In some embodiments, pre-processing the digital product search image file includes performing at least one of the processes on the image file: (1) scaling; (2) histogram equalization; (3) edge sharpening; (4) Canny edge detection; and (5) median filtering.

Scaling of an image is the process of resizing a digital image. Typically, as the scale is increased, the pixels that form the image become increasingly visible, but the quality of the image is deteriorated. Histogram equalization is a technique, which uses an image's histogram, for adjusting image intensities to enhance contrast. A histogram is typically a graphical representation of the tonal distribution in a digital image, e.g., the number of pixels in the image (vertical axis) with a particular brightness value (horizontal axis). Edge sharpening of a digital image includes sharpening the contrast between the edges of a subject and the adjacent background, thereby improving the definition of the edge. Canny edge detection includes the use of a multi-stage algorithm to detect edges in an image. Median filtering is a nonlinear digital filtering technique that is used to remove noise from digital images without distorting or softening image edges.

In some embodiments, at 208, digital product catalogue text and image files pre-processed in 206 are analyzed to extract feature data from the digital product catalogue image files. In some embodiments, extracting feature data from the digital product digital product search image file includes performing at least one of the processes on the image file after the pre-processing: (1) scale invariant feature transform (SIFT); (2) speeded-up robust features (SURF); (3) oriented BRIEF (ORB); used in the general visual recognitions and (4) histogram of oriented gradients (HOG). SIFT, SURF, and ORB are state-of-the-art feature descriptor processes that are well known and have been well-tested for effectiveness. HOG is a process that extracts character structure features and is effective in recognizing objects, textures, and scenes. In some embodiments, at 208, extracting feature data from the digital product digital product search image file includes segmentation of the image file data using clustering, blob detection, and other methods known by those skilled in the art.

In some embodiments, at 210, the feature data is classified and the content based image retrieval data is stored in the product catalogue search database. Classification of the feature data includes processing the feature data using at least one of supported vector machines (SVM) and multilayer perceptron (MLP). SVM is a learning algorithm that is trained using known examples, e.g., feature vectors included in electronic product catalogue data. MLP is a feed forward artificial neural network that maps input data, e.g., feature vectors included in electronic product catalogue data, onto output data.

At 212, a graphical user interface including mechanisms for allowing a user to upload digital product search image files of products the user desires to search is provided. At 214, a digital product search image file of a product to be searched is uploaded via the graphical user interface. After 214, method 200 returns to steps 204-210, and the digital product search image file is analyzed to determine the particularly formatted feature vectors of the digital product search image file.

At 216, the product catalogue search database is queried using the particularly formatted feature vectors of the digital product search image file to develop a ranked list of the digital product catalogue image files including particularly formatted feature vectors that most closely match the particularly formatted feature vectors of the digital product search image file. In some embodiments, querying the product catalogue search database using the particularly formatted feature vectors of the digital product search image file to develop a ranked list of the digital product catalogue image files includes identifying hue moments included in the vectors and calculating a distance between the hue moments. At 218, the digital product catalogue image and text files for each of the digital product catalogue image files on the ranked list, i.e., the query results, are displayed to the user via the graphical user interface.

Methods and systems according to the disclosed subject matter offer benefits over known technology including the following: (1) sorting functionality that allows one to sort the best products based on features extracted from any given image; (2) content based image retrieval that includes segmentation of image files to allow for identification of the main object(s) in a given image; and (3) and searching functionality that includes search terms based on text and/or image data.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. A method for searching electronic product catalogue data using search queries developed from user uploaded digital image files, said method comprising:
providing product catalogue data for a plurality of products, said product catalogue data including digital product catalogue image files, digital product catalogue text files, and content based image retrieval data having particularly formatted feature vectors, said content based image retrieval data being based on said digital product catalogue image and text files, said product data being stored in a product catalogue search database;
providing a graphical user interface including mechanisms for allowing a user to upload digital product search image files of products said user desires to search;
uploading a digital product search image file of a product to be searched via said graphical user interface;
analyzing said digital product search image file to determine said particularly formatted feature vectors of said digital product search image file;
querying said product catalogue search database using said particularly formatted feature vectors of said digital product search image file to develop a ranked list of said digital product catalogue image files including particularly formatted feature vectors that most closely match said particularly formatted feature vectors of said digital product search image file; and
displaying to said user via said graphical user interface said digital product catalogue image and text files for each of said digital product catalogue image files on said ranked list.

2. The method according to claim 1, further comprising:
analyzing digital product catalogue text and image files to develop content based image retrieval data having particularly formatted feature vectors for a plurality of products; and
storing said content based image retrieval data in said product catalogue search database.

3. The method according to claim 2, wherein analyzing digital product catalogue text and image files to develop content based image retrieval data further comprises:
pre-processing said digital product catalogue image files to facilitate extraction of features from said files;
extracting feature data from said digital product catalogue image files; and
classifying said feature data.

4. The method according to claim 1, wherein analyzing said digital product search image file to determine said particularly formatted feature vectors of said digital product search image file further comprises:
pre-processing said digital product search image file to facilitate extraction of features from said file;
extracting feature data from said digital product digital product search image file; and
classifying said feature data.

5. The method according to claim 4, wherein said pre-processing said digital product search image file includes performing at least one of said processes on said image file: (1) scaling; (2) histogram equalization; (3) edge sharpening; (4) Canny edge detection; and (5) median filtering.

6. The method according to claim 5, wherein said extracting feature data from said digital product digital product search image file includes performing at least one of said processes on said image file after said pre-processing: (1) scale invariant feature transform (SIFT); (2) speeded-up robust features (SURF); (3) oriented BRIEF (ORB); and (4) histogram of oriented gradients (HOG).

7. The method according to claim 6, wherein said classifying said feature data includes processing said feature data using at least one of supported vector machines (SVM) and multilayer perceptron (MLP).

8. The method according to claim 1, wherein contents of said particularly formatted feature vectors are dynamic.

9. The method according to claim 8, wherein communication with said product catalogue search database is done via a database abstraction layer to allow said product catalogue search database to include a non-relational, a relational, or similar database structure.

10. The method according to claim 1, wherein querying said product catalogue search database using said particularly formatted feature vectors of said digital product search image file to develop a ranked list of said digital product catalogue image files includes identifying hue moments included in said vectors and calculating a distance between said hue moments.

11. A system for searching electronic product catalogue data using search queries developed from user uploaded digital image files, said system comprising:
a product catalogue search database for a plurality of products, said product catalogue search database including digital product catalogue image files, digital product catalogue text files, and content based image retrieval data having particularly formatted feature vectors, said content based image retrieval data being based on said digital product catalogue image and text files;
a web-based user interface module including a graphical user interface having mechanisms for allowing a user to upload digital product search image files of products said user desires to search;
a query generation module in communication with said web-based user interface module, said query generation module included computer implemented methods for analyzing said digital product search image file to determine said particularly formatted feature vectors of said digital product search image file; and
a search module for querying said product catalogue search database using said particularly formatted feature vectors of said digital product search image file produced in said query generation module to develop a ranked list of said digital product catalogue image files including particularly formatted feature vectors that most closely match said particularly formatted feature vectors of said digital product search image file and displaying to said user via said graphical user interface said digital product catalogue image and text files for each of said digital product catalogue image files on said ranked list.

12. The system according to claim 11, further comprising:
a product catalogue search data analysis module for uploading product catalogue text and images for a plurality of products and analyzing said product catalogue text and images to develop content based image retrieval data having particularly formatted feature vectors for said plurality of products and storing said content based image retrieval data in said product catalogue search database.

13. The system according to claim 12, said product catalogue search data analysis module further comprising:
an image file pre-processing sub-module for pre-processing said digital product catalogue image files to facilitate extraction of features from said files;
a feature extraction sub-module for extracting feature data from said digital product catalogue image files; and
a feature classification sub-module for classifying said feature data.

14. The system according to claim 12, wherein said product catalogue search data analysis module is an offline content based image retrieval application in communication with said product catalogue search database.

15. The system according to claim 14, wherein said product catalogue search data analysis module communicates with said product catalogue search database via a database abstraction layer and a database driver.

16. The system according to claim 10, wherein said web-based user interface module communicates with said query generation module via a load balancer and a web server.

17. The system according to claim 10, wherein said query generation module includes an online content based image retrieval application.

18. The system according to claim 10, wherein said query generation module communicates with said product catalogue search database via a database abstraction layer and a database driver.

19. A method for searching electronic product catalogue data using search queries developed from user uploaded digital image files, said method comprising:
analyzing digital product catalogue text and image files to develop content based image retrieval data having particularly formatted feature vectors for a plurality of products;
storing said content based image retrieval data in a product catalogue search database, said product catalogue data including digital product catalogue image files, digital product catalogue text files, and content based image retrieval data having particularly formatted feature vectors, said content based image retrieval data being based on said digital product catalogue image and text files, said product data being stored in a product catalogue search database;
providing a graphical user interface including mechanisms for allowing a user to upload digital product search image files of products said user desires to search;
uploading a digital product search image file of a product to be searched via said graphical user interface;
analyzing said digital product search image file to determine said particularly formatted feature vectors of said digital product search image file;
querying said product catalogue search database using said particularly formatted feature vectors of said digital product search image file to develop a ranked list of said digital product catalogue image files including particularly formatted feature vectors that most closely match said particularly formatted feature vectors of said digital product search image file; and
displaying to said user via said graphical user interface said digital product catalogue image and text files for each of said digital product catalogue image files on said ranked list.

20. The method according to claim 19, wherein analyzing digital product catalogue text and image files to develop content based image retrieval data further comprises:
pre-processing said digital product catalogue image files to facilitate extraction of features from said files;
extracting feature data from said digital product catalogue image files; and
classifying said feature data.

21. The method according to claim 19, wherein analyzing said digital product search image file to determine said particularly formatted feature vectors of said digital product search image file further comprises:
pre-processing said digital product search image file to facilitate extraction of features from said file;
extracting feature data from said digital product digital product search image file; and
classifying said feature data.

22. The method according to claim 21, wherein said pre-processing said digital product search image file includes performing at least one of said processes on said image file: (1) scaling; (2) histogram equalization; (3) edge sharpening; (4) Canny edge detection; and (5) median filtering.

23. The method according to claim 22, wherein said extracting feature data from said digital product digital product search image file includes performing at least one of said processes on said image file after said pre-processing: (1) scale invariant feature transform (SIFT); (2) speeded-up robust features (SURF); (3) oriented BRIEF (ORB); and (4) histogram of oriented gradients (HOG).

24. The method according to claim 23, wherein said classifying said feature data includes processing said feature data using at least one of supported vector machines (SVM) and multilayer perceptron (MLP).

25. The method according to claim 19, wherein querying said product catalogue search database using said particularly formatted feature vectors of said digital product search image file to develop a ranked list of said digital product catalogue image files includes identifying hue moments included in said vectors and calculating a distance between said hue moments.
